(19) United States
(12) Patent Application Publication
(10) Pub. No.: US 2004/0222392 A1
(43) Pub. Date: Nov. 11, 2004

(54) Film holding device and film scanning device

(76) Inventors: Bernhard Sander, Munich (DE); Johannes Steurer, Landshut (DE)

Correspondence Address: FULBRIGHT AND JAWORSKI L L P, PATENT DOCKETING 29TH FLOOR, 865 SOUTH FIGUEROA STREET, LOS ANGELES, CA, 900172576

(21) Appl. No.: 10/817,284

(22) Filed: Apr. 2, 2004

(30) Foreign Application Priority Data
Apr. 4, 2003 (DE) 10315482.5

(51) Int. Cl. G01V 8/00; H04N 5/253

(52) U.S. Cl. 250/559.02; 348/96

(57) ABSTRACT

The invention relates to a film holding apparatus for the holding of an intermittently transmitted motion picture film. The film holding apparatus has a film track for the guiding of the motion picture film and a registration device which can be moved from a release position into an engagement position. In the engagement position, the registration device engages into the transport plane of the motion picture film to fix a motion picture film guided in the film track in an exact position. At least one alternative position can be selected alternatively to a reference position for the engagement of the registration device into the film transport plane.

The invention relates to a film holding apparatus for the holding of an intermittently transmitted motion picture film. This apparatus has at least one film track in which the motion picture film can be guided during a transport movement and a registration device which is movable from a release position into an engagement position in which the registration device engages into the transport plane of the motion picture film in order to fix a motion picture film guided in the film track in an exact position.

Such a film holding apparatus is used, for example, in a film scanning apparatus. In a film scanning apparatus, the motion picture film is transported intermittently in order to light and scan film images following one another individually, for example to digitize the film. It is not wanted in this process to scan a sequence of film images following one another of the motion picture film without image shift. The individual film images should therefore be detected in a constant relative position with respect to the film track and with respect to the light receiver used in order to avoid “jerkiness” on a later playing back of the sequence. For this purpose, the position of the motion picture film is exactly fixed between two transport movements during the standstill. For this purpose, normally a registration device engages into the perforation holes which are provided at the two longitudinal sides of the film and otherwise permit a film transport by means of a sprocket drum.

A reference perforation hole is associated with every single film image of the motion picture film in this process and defines the position of the respective film image. This definition of a reference perforation hole has the background that the recording and the playing back of a motion picture film usually takes place with different units so that now a uniform definition exists for the different units as to which position of the film is decisive for the exact positioning. Said registration device therefore usually engages at a reference position into the film transport plane, since the arrangement of the explained reference perforation hole of the motion picture film is to be expected there.

It has, however, been found to be a problem in this process if the film has been cut and spliced between two film images following one another. In this case, the cut namely extends between the film image and the associated reference perforation hole so that, after the splicing, the pre-determined exact relative position of this film image with respect to the associated reference perforation hole is no longer ensured. If this reference perforation hole is nevertheless used by means of a registration device to fix the film, an unwanted shift in the image steadiness can occur. This image shift can admittedly be corrected later as part of a digital post-processing of the image sequence. However, this is undesirably complex and expensive.

It is therefore an object of the invention to provide a film holding apparatus which avoids an image shift during the playback or scanning of a sequence of film images of a motion picture film following one another. This object is satisfied by a film holding apparatus having the features of claim 1 and in particular in that at least one alternative position can be selected as an alternative to a reference position for the engagement of the registration device into the film transport plane.

The film holding apparatus in accordance with the invention is therefore made such that the registration device can alternatively engage at a reference position or at least one alternative position into the transport plane of the motion picture film or into the perforation holes of the motion picture film. There is therefore at least one additional registration position available.

This alternative position is offset by the predetermined spacing of the perforation hole pairs of the motion picture film—or by a multiple thereof—with respect to the reference position of the registration device such that, instead of the reference perforation hole, another perforation hole or perforation hole pair can serve for the positional fixing of the film by means of the registration device. This alternatively used perforation hole is expediently arranged perpendicular to the film transport direction directly adjacent to the associated film image so that a cut of the motion picture film generally does not separate this alternative perforation hole from the associated film image. In other words, the alternative position of the registration device has been selected such that, even with cut film stock, there is always a fixed relative position of the individual film images with respect to the registration device, even if this relative position does not correspond to the norm.

The selection of either the reference position or of the alternative position of the registration device can take place uniformly or sectionally differently for the scanning of a motion picture film, with an automatic selection also being possible, as will be explained below.

The named registration device can be a single registration pin which dips into the respective perforation hole. The registration device preferably, however, has a pair of registration pins which engage into a perforation hole pair.

An advantage of the film holding device in accordance with the invention therefore consists of the fact that the image steadiness is also not impaired by any splicing position of the film and by the loss associated with this of the respective reference perforation hole for individual film images. A playback of this film or of the scanned image sequence is thereby possible without image shift and thus without “jerkiness”. An otherwise required, undesirably expensive digital post-processing for the correction of an image shift can thus be omitted.

The use of such a film holding apparatus in a film scanning apparatus is particularly advantageous, since cut and spliced film stock is frequently used there.

In accordance with a preferred embodiment, the film holding apparatus can have an additional registration device which is likewise movable between a release position and an engagement position and which engages, in its engagement position, into the film transport plane at the explained alternative position, with one of the two registration devices being able to be selected for the fixing of the motion picture film.

Alternatively to this, the registration device can be made mechanically displaceable between the reference position and the alternative position at the film holding apparatus, with in particular a fixing device being provided by which the registration device can be optionally fixed positionally exactly in the reference position or in the alternative position.

In accordance with a further alternative embodiment, at least one first and one second film holding apparatus can be provided which are made replaceably with respect to a film holder mount at a film scanning apparatus, with the registration device of the one film holding apparatus engaging, in its engagement position, into the film transport plane at the reference position and the registration device of the further film holding apparatus engaging at the alternative position. The invention also relates in this respect to a system of at least one first such film holding apparatus and one second such film holding apparatus.

In accordance with a further alternative embodiment, the registration device is arranged at the film holding apparatus such that it engages into the film transport plane at the reference position with reference to a first transport direction of the motion picture film and at the alternative position with respect to a second, opposite transport direction of the motion picture film, with the film holding apparatus being made symmetrically with respect to a swapping of the two transport directions. In other words, this film holding apparatus can be inserted into a film holding receiver, for example of a film scanning apparatus, in two different alignments such that, optionally, the reference position or the alternative position of the registration device is set. A change between the reference position and the alternative position of the registration device takes place in that the film holding apparatus is removed from the film holder receiver and is rotated through 180°. The housing and the mechanical and possible electrical connection sections of this film holding apparatus are made accordingly symmetrically.

With film scanning apparatuses, there is also the problem that the motion picture film usually has a natural transverse arching inside a plane perpendicular to the longitudinal direction of the film or perpendicular to the film transport direction (so-called “curl”). The film can furthermore have a longitudinal arching along the longitudinal direction of the film after storage on a winding reel. Such archings can result in unwanted distortion effects of the scanned image on a scanning of the film. To eliminate this problem, provision is made in accordance with a further development of the invention for the film holding apparatus to have a pressure frame which is movable between a release position and a pressure position, with the pressure frame releasing, in the release position, the motion picture film guided in the film track for a transport movement and in the pressure position, together with a counter-pressure frame, bounding a holding slot in which the motion picture film located in the film track is captured substantially free of clearance.

The pressure frame can be intermittently raised from the film and pressed onto the film synchronized with the transport movement of the motion picture film. In the release position, the pressure frame moves back from the transport plane of the motion picture film such that generally no more contact takes place between the pressure frame and the motion picture film guided in the film track. In the pressure position, the pressure frame forms a holding slot together with the counter-pressure frame. The clearance of this holding slot is dimensioned such that the motion picture film is captured in the holding slot without pressure force. Only a minimum arching of the captured film is thereby still possible.

The film holding apparatus thus permits the motion picture film to be brought into a planar position during a standstill. A possible arching of the film is thus reduced to a minimum. Image distortion on a scanning or exposure of the film is thereby avoided. The light contact of the film at the pressure frame or at the counter-pressure frame caused by an existing arching moreover prevents an unwanted slipping or wobbling of the film so that the image steadiness is improved even further. No image regions of the motion picture film are contacted in this process. The film safety is also not endangered by possible splicing positions, since such splicing positions can pass the film holding apparatus without problem when the pressure frame is moved back into the release position.

The invention further relates to a film scanning apparatus for the scanning of an exposed motion picture film comprising a film holding apparatus for the holding of the film, a film drive device for the intermittent transporting of the film, a light source for the transmission of transmitted light in the direction of the film holding apparatus and an optoelectronic light receiver for the receiving of the light transmitted by the film holding apparatus and for the production of corresponding signal values, with the film holding apparatus having a film track and a registration device and being formed in the explained manner. At least one alternative position can in particular be selected as an alternative to a reference position for the engagement of the registration device into the film transport plane.

Further embodiments of the invention are recited in the dependent claims.

The invention will be described in the following by way of example with reference to the drawings.

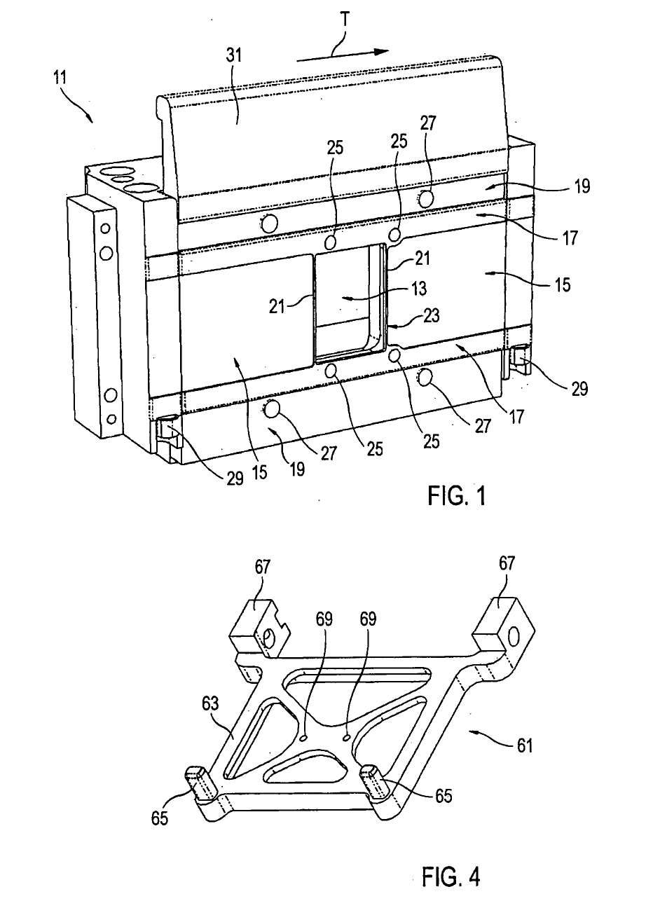

FIG. 1 shows an image window part obliquely from below;

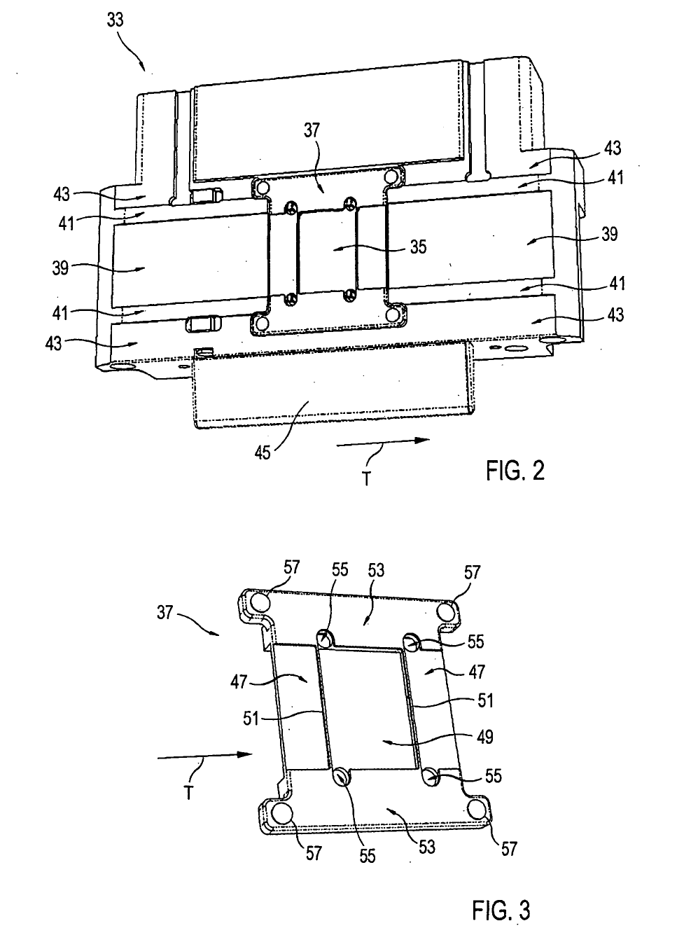

FIG. 2 shows a film track with a pressure frame obliquely from above;

FIG. 3 shows the pressure frame in accordance with FIG. 2 in a perspective view obliquely from above;

FIG. 4 shows a registration device in a perspective view obliquely from above;

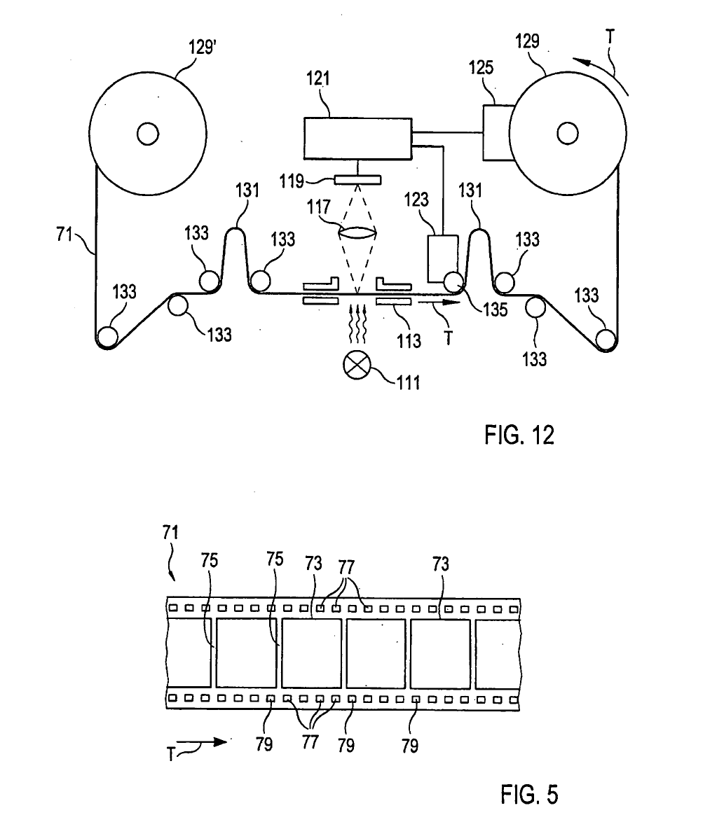

FIG. 5 shows a section of a motion picture film in a plan view;

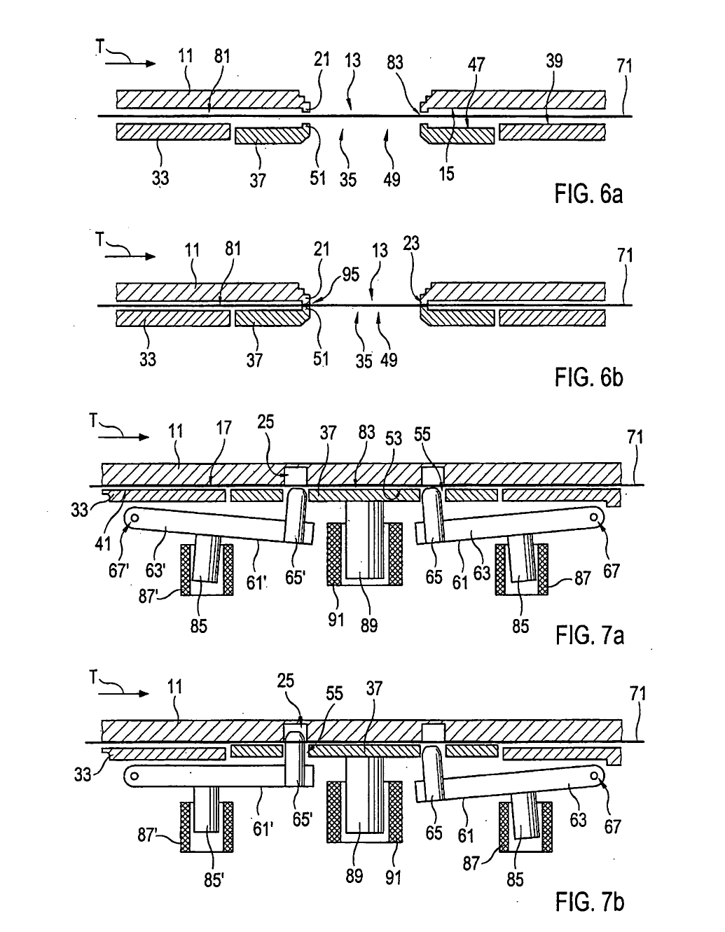

FIGS. 6a and 6b show a film holding apparatus in a schematic central cross-sectional view parallel to the film transport direction in a release position or in a holding position;

FIGS. 7a and 7b show the film holding apparatus in a schematic cross-sectional view parallel to the film transport direction and laterally offset with respect to the central cross-sectional view in accordance with FIGS. 6a and 6b in a release position or in a holding position;

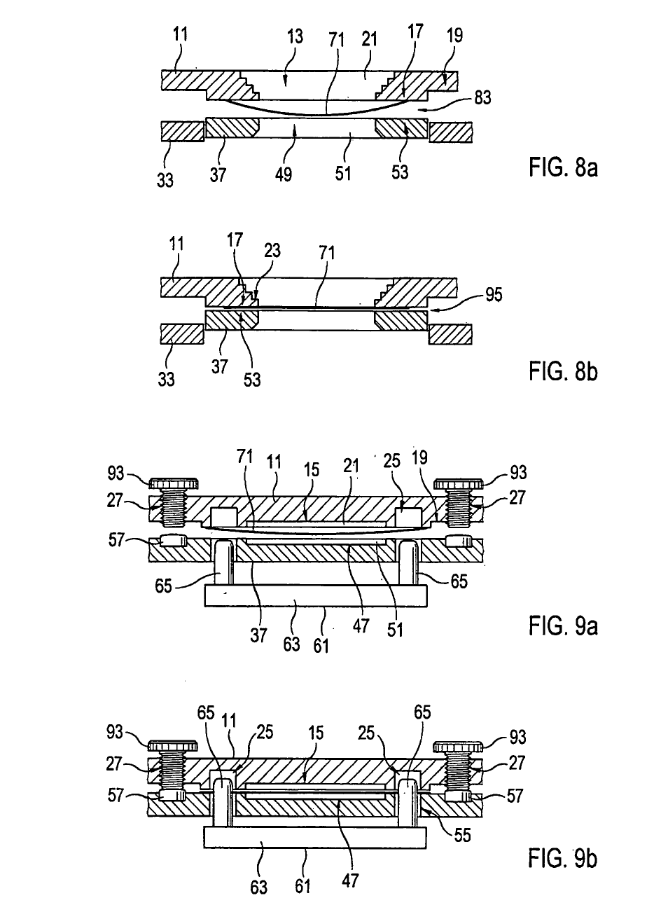

FIGS. 8a and 8b show the film holding apparatus in a schematic central cross-sectional view perpendicular to the film transport direction in a release position or in a holding position;

FIGS. 9a and 9b show the film holding apparatus in a schematic cross-sectional view perpendicular to the film transport direction and offset along the film transport direction with respect to the central cross-sectional view in accordance with FIGS. 8a and 8b in a release position or in a holding position;

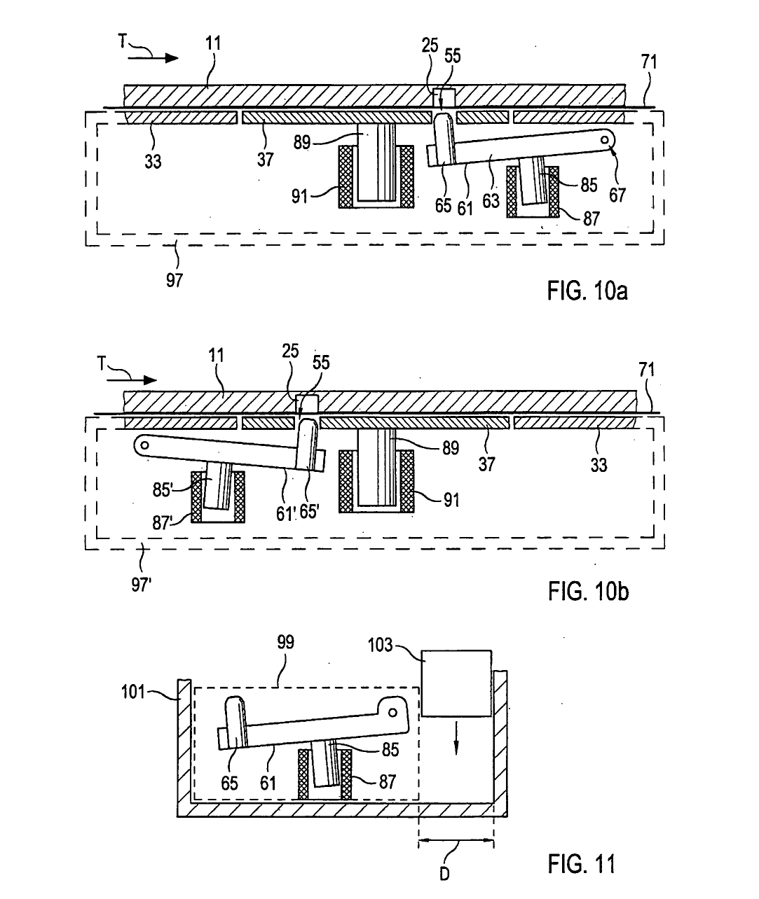

FIGS. 10a and 10b show an alternative embodiment of the film holding apparatus in accordance with FIGS. 7a and 7b;

FIG. 11 shows a further alternative embodiment of the film holding apparatus;

FIG. 12 shows a film scanning apparatus in a schematic side view.

FIGS. 1 to 4 show some components of a film holding apparatus. FIG. 1 shows an image window part 11 obliquely from below. The image window part 11 is substantially of right parallelepiped shape with a central window cut-out 13. Two recess sections 15, which are each adjacent to the window cut-out 13, extend along a film transport direction T at the shown lower side of the image window part 11. The recess sections 15 are bounded perpendicular to the film transport direction T by a respective polished film support section 17. The film support sections 17 extend along the film transport direction T and are in turn laterally outwardly adjacent to a respective outer recess section 19

The film support sections 17 are made elevated by approximately 500 μm (0.5 mm) with respect to the inner recess sections 15 and to the outer recess sections 19. The elevated film support sections 17 merge into two transverse webs 21 which extend perpendicular to the film transport direction T and thereby form the lateral boundaries of the window cut-out 13. The transverse webs 21 are thus likewise made elevated with respect to the inner recess sections 15. Together with those regions of the film support sections 17 which bound the further side edges of the window cut-out 13, the two transverse webs 21 thus form a counter-pressure frame 23 whose function will be explained in the following.

Two respective pin receivers 25 are furthermore shown at the film support sections 17 in the region of the window cut-out 13. Furthermore, two respective set screw threaded bores 27 can be recognized at the two outer recess sections 19. Finally, the image window part has two side guiding elevations 29 adjoining the one film support section 17. An upper film threading wing 31 is moreover molded to the opposite side of the image window part 11.

FIG. 2 shows a film track 33 associated with the image window part 11 obliquely from above. The film track 33 is also substantially of right parallelepiped shape with a central window cut-out 35 which is surrounded by a movable pressure frame 37. The pressure frame 37 is also shown separately in FIG. 3.

Two inner recess sections 39 are likewise provided at the upper side of the film track 33 shown in FIG. 2 and extend along the film transport direction T and each adjoin the window cut-out 35. Four polished film support sections 41 each extend along the film transport direction T laterally outwardly adjacent thereto. They are again bordered at the side by outer recess sections 43. The film support sections 41 are made elevated with respect to the recess sections 39 and 43. A lower film threading wing 45 is moreover molded to the side of the film track 33.

The pressure frame 37 is held in a shape matched manner in the film track 33 and is slightly movable perpendicular to the plane of extent of the film support sections 41, as will be explained in the following.

As can be seen from FIG. 3, the pressure frame 37 likewise has two recess sections 47 which are each separated from a central window cut-out 49 by an elevated transverse web 51. A respective polished film support section 53 laterally outwardly adjoins the recess sections 47 and the window cut-out 49. The two film support sections 53 extend along the film transport direction T and are made elevated with respect to the recess sections 47 such that the film support sections 53 ultimately have the same height as the transverse webs 51 and merge into these.

Two pin cut-outs 55 are formed at each film support section 53 in the surroundings of the window cut-out 49. Furthermore, the upper side of the pressure frame 37 shown in FIG. 3 is fitted with four contact elements 57 which are inserted into the pressure frame 37 as hardened steel mushrooms.

FIG. 4 shows a registration pin lever 61 obliquely from above. The registration pin lever 61 has a frame section 63. Two registration pins 65 are attached to an end of the frame section 63. Two hinge projections 67 are molded to the other end of the frame section 63. Two securing bores 69 are provided in a central region of the frame section 63.

FIG. 5 shows a section of a motion picture film 71 in a plan view. The motion picture film 71 has a plurality of image regions 73 in an equidistant arrangement along its longitudinal direction which each correspond to an exposed single image or to a single image to be exposed of the film. Two adjacent image regions 73 are each separated from one another by a separation region 75. A regular arrangement of perforation holes 77 is provided at each of the two longitudinal sides of the motion picture film 71.

In accordance with the German Industrial Standard, a reference perforation hole 79 is associated with each image region 73, with said reference perforation hole 79 being arranged at the height of the adjacent image region 73 in the film transport direction T. This standard has the sense that a fixed relative position is defined between an image region 73 and a fixing device which fixes the motion picture film 71 during the brief standstill for the recording and subsequent playback of the motion picture film 71 with different units. A constant image steadiness is thereby ensured such that no image shift occurs on the playback of the sequence of image regions 73.

The image window part 11 in accordance with FIG. 1, the film wall 33 in accordance with FIG. 2, the pressure frame 37 in accordance with FIG. 3 and the registration pin lever 61 in accordance with FIG. 4 are components of a film holding apparatus. It serves for the holding and guiding of a motion picture film 71, for example in a film scanning apparatus. The motion picture film 71 is moved intermittently in this process by means of a sprocket drum engaging at the perforation holes 77, 79 such that the individual image regions 73 can be scanned after one another. The registration pin lever 61 with the registration pins 65 ensures in this process a positionally exact fixing of the motion picture film 71 during the standstill of the motion picture film 71 and, supplementary thereto, the pressure frame 37 brings about an elimination of possible archings of the respective image region 73.

For this purpose, the image window part 11 and the film track 33 are mounted to one another such that the lower side of the image window part 11 shown in FIG. 1 lies on the upper side of the film track 33 shown in FIG. 2 and a guide passage 81 is formed by the respective inner recess sections 15 or 39 and the motion picture film 71 can be moved inside this along the film transport direction T (cf. FIGS. 6a and 6b). The pressure frame 73 is enclosed between the image window part 11 and the film track 33 in this process. One or more registration pin levers 61 are pivotably hinged to the lower side of the film track 33, as will be explained in the following. The window cut-outs 13, 35 and 49 of the image window part 11, of the film track 33 and of the pressure frame 37 are arranged flush in this process such that a common window cut-out is formed through which an image area 73 of the motion picture film 71 can be scanned.

FIGS. 6a and 6b show the film holding apparatus mounted in this manner in a schematic central cross-sectional view along the transport direction T. FIG. 6a shows the apparatus in a release state in which the pressure frame 37 is retracted into a release position, that is has been moved downwardly in the representation in accordance with FIG. 6. The motion picture film 71 can be moved in a completely non-contact manner in the guide passage 81. The narrowest point of this guide passage 81 is formed by a release slot 83 between the transverse webs 21 of the image window part 11 and the transverse webs 51 of the pressure frame 37.

The release slot 83 has such a clearance that no contact to the transverse webs 21, 51 takes place even with a certain arching of the motion picture film 71. The spacing between the transverse webs 21, 51 can, for example, amount to approximately 500 μm (0.5 mm) or more. The clearance of the guide passage 81 formed between the image window part 11 and the film track 33 can be selected to be in the same order of magnitude or even larger.

FIG. 8a shows the explained release state of the film holding apparatus in a schematic cross-sectional view along a plane which extends perpendicular to the transport direction T and through the window cut-out 49 of the pressure frame 37.

FIG. 7a shows this release state in a schematic cross-sectional view along a plane which is offset laterally with respect to the cross-sectional plane in accordance with FIG. 6a and extends in this process through the registration pins 65, 65′ of two registration pin levers 61, 61′. It can be recognized that the side edges of the motion picture film 71 with the peroration holes 77, 79 are guided between the film support sections 77 and 41 of the image window part 11 and of the film track 33. The registration pin levers 61, 61′ are also located in a release position in which the motion picture film 71 is released for a transport movement.

It can also be seen from FIG. 7a that the registration pin levers 61, 61′, pivotably supported at the respective hinge projections 67, 67′ can be driven by means of a respective moving coil drive. For this purpose, magnetic plungers 85, 85′ are provided at the securing bores 69 at the lower side of the registration pin levers 61, 61′ and project into a respective moving coil 87, 87′. It can furthermore be seen from FIG. 7a that the pressure frame 37 also has a moving coil drive with a magnetic plunger 89 and a moving coil 91. It is naturally possible to provide other electrical or mechanical types of drive instead of the explained moving coil drives.

Finally, FIG. 9a shows the release state of the apparatus in a schematic cross-sectional view along a plane which in turn extends perpendicular to the film transport direction, and indeed through the registration pins 65 of the registration pin lever 61. An adjustment device with adjustable screws 93 is furthermore visible from FIG. 9a.

FIG. 6b shows the film holding apparatus in a holding state in a view corresponding to the cross-sectional view in accordance with FIG. 6a. The motion picture film 71 has now come to a standstill after a transport movement in order, for example, to be able to scan an image region 73. During the standstill of the motion picture film 71, one of the registration pin levers 61, 61′ has been moved upwardly by a corresponding control of the moving coils 87, 87′ such that the respective registration pins 65, 65′ now engage through the grip cut-outs 55 of the pressure frame 37 into the perforation holes 77, 79 of the motion picture film 71 and into the grip receivers 25 of the image window part 11 (FIG. 7b). The position of the motion picture film 71 within the film holding apparatus is thereby precisely defined.

The pressure frame 37 has moreover been moved by a corresponding control of the moving coil 91 out of the release position in accordance with FIG. 6a into a pressure position in which it bounds a holding slot 95 together with the counter pressure frame 23 of the image window part 11. The motion picture film 71 is now substantially captured without clearance in this holding slot 95. The transverse webs 21 and 51 of the image window part 11 and of the pressure frame 37 now stand precisely opposite one another (FIG. 6b). Perpendicular thereto, the film support sections 17 of the image window part 11 and the film support sections 53 of the pressure frame 37 surround the motion picture film 71 (FIG. 8b). This fixing of the motion picture film 71 by means of two cooperating peripheral frames 23 and 37 has the effect that the film 71 is brought into a planar position at the window cut-outs 13, 35, 49 such that optical distortion is avoided on a scanning or exposure of the enclosed image region 73.

Contact with the film 71 only takes place in this process at the marginal regions having the perforation holes 77, 79 and along the dividing regions 75 at which the film 71 does not contain any image information. No pressure force is actively exerted on the motion picture film 71. A possible force transmission of the film 71 inside the holding slot 95 results at most from a previously present arching and now eliminated arching of the film 71. For this purpose, a value for the clearance of the holding slot can be provided, for example, which corresponds to the sum of the thickness of the motion picture film 71 (for example 160 μm) and of a safety spacing of approximately 20 μm.

A special feature of the explained film holding apparatus consists of the fact that an alternative position can be selected as an alternative to a reference position on the basis of the design with two registration pin levers 61, 61′ for the engagement of the registration pins 65, 65′ into the perforation holes 77 of the film 71. As has already been explained with reference to FIG. 5, the reference perforation holes 79 serve for the precise fixing of the position of the respectively associated image region 73, in particular if the film 71 is intended to be used in different units.

If, however, a cutting and a subsequent splicing of the film 71 takes place along a dividing region 75 in the meantime, the reference perforation hole 79 is thereby separated from the associated image region 73 such that the precise spatial association is no longer given even after a subsequent splicing. It has proved to be advantageous for such a case for the motion picture film 71 not necessarily to be fixed at the reference perforation holes 79 inside the film holding apparatus, but for the registration pins 65, 65′ instead to engage into different perforation holes 77 which are directly adjacent to the respective image region 73.

This is possible in the embodiment shown in that, as shown in FIGS. 7a and 7b, the further registration pin lever 61′ is provided in addition to the registration pin lever 61. The additional registration pin lever 61′ is hinged to the film track 33 in this process such that the registration pins 65′ do not engage into reference perforation holes 79 in their engagement position, but into such perforation holes 77 which are arranged directly adjacent at the side with respect to the relevant image region 73 (cf. FIG. 5).

Provision is made in this process for only one of the two registration devices 61, 61′ respectively to be selected for the fixing of the motion picture film 71. This selection can take place in that the respective relevant moving coil drive is controlled to bring only the associated registration pin lever 61, 61′ into the gripper position.

FIGS. 10a and 10b show an alternative possibility to realize the explained selection option of the position of the registration pin engagement. FIG. 10a shows a film track housing 97 in a cross-sectional view corresponding to the representation in accordance with FIG. 7a. It includes a registration pin lever 61 with registration pins 65. The registration pin lever 61 is pivotably hinged to the film track housing 97 and is movable by means of a plunger 85 and a moving coil 87 between a release position in accordance with FIG. 10a and a gripper position, as has already been explained.

The film track housing 97 furthermore optionally includes a pressure frame 37 which can likewise be moved by means of a plunger 89 and a moving coil 91 to make a movement between a release position in accordance with FIG. 10a and a pressure position.

The film track housing 97 is made such that, when inserted in the correct position into a film holding receiver of a film scanning apparatus or the like, the registration pin levers 65 engage in the gripper position of the registration pin lever 61 into the reference perforation holes 79 of the motion picture film 71 used. In other words, the film track housing 97 is configured such that the registration pin lever 61 always engages into the film transport plane in the reference position.

In addition to the explained film track housing 97 in accordance with FIG. 10a, a further film track housing 97′ is provided which is shown in FIG. 10b in a cross-sectional view corresponding to FIG. 10a. This additional film track housing 97′ also has a registration pin lever 61′ and, optionally, a pressure frame 37 with respective moving coil drives. However, the registration pin lever 61′ is arranged in such a manner here that, in the position of use of the film track housing 97′, it always engages into the film transport plane in an alternative position, when the registration pin lever 61′ is moved out of the release position in accordance with FIG. 10b into a gripper position.

The two film track housings 97, 97′ thus form—optionally together with an image window part—a system of two film holding apparatuses. Depending on whether a motion picture film 71 should be fixed to the reference perforation holes 79 or to alternative perforation holes 77, the one film track housing 97 or the other film track housing 97′ can be selected.

Instead of such a system of a plurality of film track housings 97, 97′ to be used alternatively, one single film track housing can also be made symmetrically at its outer side such that it can be alternatively inserted in two different alignments into a film holder apparatus of a film scanning apparatus or the like. A registration pin lever is arranged inside such a film track housing such that the associated registration pins engage either into the reference perforation holes 79 or into the alternative perforation holes 77 of the motion picture film 71 used in dependence on the selected alignment of the film track housing.

FIG. 11 shows a further possibility for the realization of the selectable register position in a cross-section corresponding to the representation in accordance with FIGS. 7a and 10a. A registration pin lever 61 is also provided here with a frame section 63, registration pins 65 and a hinge projection 67. This registration pin lever 61, together with a plunger 85 and a moving coil 87 forms a registration pin unit 99, with the registration pin lever 61 being pivotably supported inside this registration pin unit 99.

The registration pin unit 99 is arranged inside a housing 101. The unit 99 can be displaced by a displacement spacing D within the housing 101 in order to alternatively adopt a reference position or—as shown in FIG. 11—an alternative position. The housing 101 can be mounted, for example, to the lower side of a film track 33, as is shown in FIG. 2.

The registration pin unit 99 and the housing 101 are preferably made in shape matched form to one another in order to be able to contact one another completely without clearance. A centering abutment V-shaped in plan view can, for example, be provided at both sides of the housing 101. It is moreover preferred for a fixing device, for example an insertion part 103, to be provided. The registration pin unit 99 can be fixed in a precise position inside the housing 101 by this fixing device. A tool-free release, displacement and fixing of the registration pin unit 99 is in particular possible in this process.

In accordance with an optional further development of the explained film holding apparatus, an adjustment device is provided by which the minimum clearance of the holding slot 95 can be varied in the pressure position of the pressure frame 37 in order, for example, to match the apparatus to different film thicknesses. For this purpose, the adjustable screws 93 shown in FIGS. 9a and 9b are provided which cooperate with the contact elements 57 of the pressure frame 37.

Finally, FIG. 12 illustrates a possible use of a film holding apparatus of the explained kind. FIG. 11 shows a film scanning apparatus with a light source 111 which, for example, has a plurality of light emitting diodes of different color. This emits homogeneous light pulses of a predeterminable transmitted light color in the direction of a film holding apparatus 113 of the explained kind in which an exposed motion picture film 71 is held.

An optical reception system 117, for example a converging lens, is arranged on the opposite side of the film holding apparatus 113. It images a back lit image region 73 of the motion picture film 71 onto a spatially resolving light receiver 119, for example onto a CMOS sensor. The light receiver 119 is connected to a control and evaluation circuit 121 which, for example, has a microprocessor. The control and evaluation circuit 121 is connected to two drive devices 123, 125.

The motion picture film 71 is guided between two winding reels 129, 129′ while forming two balancing loops 131 along a plurality of deflection rolls 133. The winding reel 129 and a transport roll 135 are driven by the drive device 123 or 125 and move the motion picture film 71 to make a transport direction intermittently in a transport direction T.

The apparatus shown in FIG. 12 serves for the scanning and digitizing of the sequential image regions 73 of the motion picture film 71. For this purpose, the motion picture film 71 is guided step-wise through the film holding apparatus 113. On every standstill of the film 71, its position is precisely fixed by means of the registration pin lever 61 and the pressure frame 37 is optionally moved into the pressure position, as was explained in detail. The control and evaluation circuit 121 provides the corresponding synchronization of the drive devices 123, 125 and of the moving coil drives 85, 87 and 89, 91. As soon as the position of the motion picture film 71 has been fixed inside the film holding apparatus 113, the control and evaluation circuit 121 controls the light source 111 and the light receiver 119. The motion picture film 71 is thereby illuminated sequentially with the thee primary colors red, green and blue and respectively associated scanned images are produced by means of the light receiver 119 which are subsequently digitized.

It must still be noted with respect to the film scanning apparatus in accordance with FIG. 12 that the desired reference position or alternative position of the registration pin lever 61, 61′ of the film holding apparatus 113 can be selected either uniformly for the total scan process or also only for some sections of the motion picture film 71 to be scanned. An automatic selection is also possible in this process.

For example, the control and evaluation circuit 121 can have an image detection circuit by which a degree of change can be determined which corresponds to the extent of a change of the image information of two image regions 73 of the motion picture film scanned sequentially. The control and evaluation circuit 121 causes a scanning of the respective image region 73 both in the reference position and in the alternative position of the registration pin lever 61, 61′ when the determined degree of change exceeds a pre-determined change threshold value. Two scanned images are thus available as a precaution so that, if required, that scanned image can later be used for the scanned image sequence which corresponds to the alternative position of the registration pin lever 61, 61′.

Alternatively to this, an automatic selection of a suitable position of the registration pin lever 61, 61′ can also take place with reference to a change of the so-called key code. This key code is attached to the marginal region of a customary motion picture film 71 and ultimately corresponds to a continuous numbering. The key code can be detected automatically such that a precautionary selection of the alternative position for the registration pin lever 61, 61′ can be initiated when a change of the key code allows a cut position to be assumed.

Finally, the film scanning apparatus in accordance with FIG. 12 can also have a regulation circuit by which the engagement depth of the registration pin lever 61 or of the registration pins 65 into the motion picture film 71 can be regulated. This regulation circuit takes into account the actual engagement depth and the actual engagement force in this process. The engagement depth can, for example, be determined with reference to the action on a spatially resolving photoelement (PSD) by a laser beam which is reflected by a mirror connected to the registration pin lever 61. The engagement force can be determined, for example, from the amount of the electric current led through the associated moving coil 87. Such a regulation ensures a particularly careful handling of the motion picture film 71. Such a regulation circuit does not necessarily have to be part of the control and evaluation circuit 121, but can be integrated directly into the film holding apparatus 113.

### Reference Numeral List

11 image window part

13 window cut-out

15 inner recess section

17 film support section

19 outer recess section

21 transverse web

23 counter-pressure frame

25 pin receiver

27 adjustable screw threaded bore

29 side guidance elevation

31 upper film threading wing

33 film track

35 window cut-out

37 pressure frame

39 inner recess section

41 film support section

43 outer recess section

45 lower film threading wing

47 recess section

49 window cut-out

51 transverse web

53 film support section

55 pin cut-out

57 contact element

61, 61′ registration pin lever

63, 63′ frame section

65, 65′ registration pin

67, 67′ hinge projection

69, 69′ securing bore

71 motion picture film

73 image region

75 separating region

77 perforation hole

79 reference perforation hole

81 guide passage

83 release slot

85, 85′ plunger

87, 87′ moving coil

89 plunger

91 moving coil

93 adjustable screw

95 holding slot

97, 97′ film track housing

99 registration pin unit

101 housing

103 insertion part

111 light source

113 film holding apparatus

117 optical receiving system

119 light receiver

121 control and evaluation circuit

123, 125 drive device

129, 129′ winding reel

131 balance loop

133 deflection roll

135 transport roll

D displacement spacing

T film transport direction

1. A film holding apparatus for the holding of an intermittently transported motion picture film (71) comprising:
a film track (33) for guiding the motion picture film; and
a registration device (61, 61′) which is movable from a release position into an engagement position in which the registration device engages into the transport plane of the motion picture film (71) in order to fix a motion picture film guided in the film track in an exact position,
characterized in that
at least one alternative position can be selected as an alternative to a reference position for the engagement of the registration device is (61, 61′) into the film transport plane.

2. A film holding apparatus in accordance with claim 1, characterized in that the film holding apparatus has an additional registration device (61′) which engages, in its engagement position, into the film transport plane of the motion picture film (71 at the alternative position), with one of the two registration devices (61, 61′) being able to be selected for the fixing of the motion picture film.

3. A film holding apparatus in accordance with claim 2, characterized in that an electrical drive device (85, 87; 85′, 87′) is provided for the moving of the registration devices (61, 61′) from the release position into the engagement position, with the drive device being able to be controlled such that one of the two registration devices is alternatively brought into the engagement position.

4. A film holding apparatus in accordance with claim 1, characterized in that the registration device (99) is formed to be displaceable between the reference position and the alternative position at the film holding apparatus (101), with a fixing device (103) preferably being provided by which the registration device can be fixed in a precise position alternatively in the reference position or in the alternative position.

5. A film holding apparatus in accordance with claim 1, characterized in that the registration device is arranged at the film holding apparatus such that the registration device engages into the film transport plane with respect to a first transport direction of the motion picture film at the reference position and into the film transport plane with respect to a second, opposite transport direction of the motion picture film at the alternative position; and
in that the film holding apparatus is formed symmetrically with respect to a swapping of the transport directions.

6. A film holding apparatus in accordance with any one of the preceding claims, characterized in that the film holding apparatus has a pressure frame (37) which is movable between a release position and a pressure position, with the pressure frame releasing, in the release position, a motion picture film (71) guided in the film track for a transport movement, and with the pressure frame, together with a counter-pressure frame (23), bounding a holding slot (95) in which the motion picture film (71) located in the film track is captured substantially free of clearance in the pressure position.

7. A film holding apparatus in accordance with claim 6, characterized in that the height of the holding slot (95) in the pressure position of the pressure frame (37) is set or can be set to a value which corresponds to the sum of the thickness of a motion picture film (71) and to a safety spacing of approximately 20 μm.

8. A film holding apparatus in accordance with one of the claims 6 or 7, characterized in that the film holding apparatus has an adjustment device (93) by which the height of the holding slot (95) can be varied in the pressure position of the pressure frame.

9. A film holding apparatus in accordance with one of claims 6 to 8, characterized in that, in the release position, the pressure frame (37), together with the counter-pressure frame (23), bounds a release slot (83), whose height preferably amounts to at least 500 μm.

10. A film holding apparatus in accordance with one of claims 6 to 9, characterized in that the pressure frame (37) has two projecting transverse webs (51) which extend perpendicular to the transport direction (T) of the motion picture film at that side which faces the transport plane of the motion picture film (71).

11. A film holding apparatus in accordance with any one of the preceding claims, characterized in that a moving coil drive (85, 87; 85′, 87′) is provided to move the registration device (61, 61′) between the release position and the engagement position.

12. A film holding apparatus in accordance with any one of the preceding claims, characterized in that the film holding apparatus is connected to a regulation circuit by which the engagement depth of the registration device can be regulated relative to the film track, with the regulation circuit taking account of the actual engagement depth and the actual engagement force of the registration device.

13. A system of at least one first film holding apparatus (97) and one second film holding apparatus (97′) for holding a motion picture film (71), with the first and the second film holding apparatus each having
a film track (33) for guiding the motion picture film; and
a registration device (61, 61′) which is movable from a release position into an engagement position in which the registration device engages into the transport plane of the motion picture film in order to fix a motion picture film guided in the film track in an exact position,
characterized in that
the registration device (61) of the first film holding apparatus (97) engages, in its engagement position, into the transport plane of the motion picture film (71) at a reference position and the registration device (61′) of the second film holding apparatus (97′) engages, in its engagement position, into the transport plane of the motion picture film (71) at an alternative position.

14. A film scanning apparatus for the scanning of an exposed motion picture film (71) comprising
at least one film holding apparatus (113) for holding the motion picture film;
a film drive device (123, 125) for the intermittent transporting of the motion picture film;
a light source (111) for the transmission of transmitted light in the direction of the film holding apparatus; and
an optoelectronic light receiver (119) for the reception of the light transmitted by the film holding apparatus and for the production of corresponding signal values,
wherein the film holding apparatus has a film track (33) for the guiding of the motion picture film and a registration device (61, 61′) which is movable from a release position into an engagement position in which the registration device engages into the transport plane of the motion picture film (71) in order to fix a motion picture film guided in the film track in an exact position; and
wherein the film holding apparatus (113) is in particular formed in accordance with any one of the preceding claims,
characterized in that
at least one alternative position can be selected alternatively to a reference position for the engagement of the registration device (61, 61′) into the film transport plane.

15. A film scanning apparatus in accordance with claim 14, characterized in that the film scanning apparatus has a control and evaluation circuit (121) by which the position of the engagement of the registration device (61, 61′) into the film transport plane can be selected automatically.

16. A film scanning apparatus in accordance with claim 15, characterized in that the control and evaluation circuit (121) has an image detection circuit by which a degree of change can be determined which corresponds to the extent of a change of the image information of two film images (73) scanned sequentially; and
in that the control and evaluation circuit initiates a double scan of a film image with the registration device (61, 61′) in the reference position and in the alternative position when the degree of change determined with respect to this film image exceeds a pre-determined change threshold value.
